(19) United States
(12) Patent Application Publication
(10) Pub. No.: US 2013/0309956 A1
(43) Pub. Date: Nov. 21, 2013

(54) Air Extractor to Relieve Changes in Air Pressure in Automobiles

(71) Applicants: Tim A. Mouch, Troy, MI (US); Richard A. Jeryan, Beverly Hills, MI (US); Michael Azzouz, Livonia, MI (US)

(72) Inventors: Tim A. Mouch, Troy, MI (US); Richard A. Jeryan, Beverly Hills, MI (US); Michael Azzouz, Livonia, MI (US)

(73) Assignee: FORD GLOBAL TECHNOLOGIES, LLC, Dearborn, MI (US)

(21) Appl. No.: 13/950,662

(22) Filed: Jul. 25, 2013

Related U.S. Application Data
(63) Continuation-in-part of application No. 11/865,021, filed on Sep. 30, 2007.

(51) Int. Cl. B60H 1/24

(52) U.S. Cl. CPC B60H 1/249
USPC 454/165

(57) ABSTRACT

An air extraction apparatus for automotive vehicles opens an air flow path through the passenger compartment of the vehicle when wind throb conditions are sensed in the operation of the vehicle. The air extraction opening is located in a rear facing surface of the vehicle and is covered by a closure member that is movable by an actuator to selectively open the air extraction opening. The air extraction opening can be variable in cross-sectional area through the operation of the closure member to vary the rate of air flowing through the passenger compartment. The actuator is operatively coupled to a sensor that can sense wind throb conditions to affect an automatic opening of the air extraction opening. Wind throb conditions can be the existence of a single open window coupled with a minimum operating speed, or a threshold interior air pressure within the passenger compartment.

### CROSS-REFERENCE TO RELATED APPLICATIONS

This application is a continuation-in-part of U.S. patent application Ser. No. 11/865,021, filed on Sep. 30, 2007, now abandoned.

### FIELD OF THE INVENTION

This invention relates to the wind throb phenomenon typically experienced in automobiles when a single window is open during forward movement of the vehicle, and, more particularly, to an active air extractor that will allow an equalization of air pressure within an automobile, including the air pressures created by an open window during operation of a vehicle to cause environmental conditions during which the wind throb phenomenon is experienced.

### BACKGROUND OF THE INVENTION

The wind throb phenomenon is experienced when air is blown across a single open window while the vehicle is moving on the highway. The wind throb phenomenon is prevalent in vehicles having relatively flat sides, such as sport utility vehicles (SUV's) and cross over vehicles, and is experienced less often, or less severely, in vehicles having curvature in the windows. With only one window open in the vehicle, the air from outside the vehicle is trying to get inside the vehicle to force air from inside the vehicle to the outside, and the single open window becomes the only path by which air can enter and leave the vehicle, as is represented in FIG. 2 in the drawings. Air trying to enter through the open window into the vehicle generates a low frequency pressure pulsation caused by the air entering the vehicle trying to be in equilibrium with the air already filling the vehicle passenger compartment.

Because vehicle cabins are constructed so tightly, air pressure increases can also be generated by the closing of doors on the vehicle when the window is closed to the extent that the increased air pressure can make the vehicle doors harder to close than if the door window were opened at the time the door was being closed. Alleviation of the increased air pressure, whether caused by environmental conditions associated with wind throb or with the closing of a vehicle door, can provide an enhancement to the operation of the vehicle and in the comfort of operating an automotive vehicle.

An air outlet aperture is provided in a wall of the luggage compartment of an automotive vehicle to extract air from the passenger compartment of the vehicle is disclosed in U.S. Pat. No. 4,920,865, granted on May 1, 1990, to Renato Pasquali, et al. This air outlet aperture is formed in the side wall of the luggage compartment and incorporates a flap valve that allows air to exit the luggage compartment when a positive pressure is attained in the luggage compartment. The air outlet aperture is operable to provide an outlet for stale air within the closed passenger compartment when exterior air is introduced into the closed passenger compartment by ducts, which are typically found in the dashboard or in the doors. In U.S. Pat. No. 6,866,576, granted to Shawn Quinn, et al on Mar. 15, 2005, a pressure relief valve is disclosed to provide relief in the event of a sudden build-up of air pressure within the passenger compartment, such as when a door of the vehicle is slammed shut. This relief valve enables a flow of air from inside the passenger compartment to be directed to the atmosphere outside of the vehicle.

Ventilating windows are taught in U.S. Pat. No. 5,864,989, issued to Masayoshi Funatsu, et al on Feb. 2, 1999, and in U.S. Pat. No. 5,984,773, issued on Nov. 16, 1999, to Yves Gervais, et al. In the Funatsu patent, the ventilating window is automatically opened by a sensor that detects the difference in atmospheric pressure between the inside and the outside of the window. In the Gervais patent, a regulating apparatus for the internal pressure of a ventilated closed volume subjected to variations in external pressure is disclosed such that the difference between the air extraction flow rate and the intake air flow rate compensates for the leakage flow rate to maintain the internal pressure at a constant level. In Japanese Patent Publication No. JP 61-169374 of Aso Kaneichi, et al, published on Jul. 31, 1986, microphones are installed to detect a throb sound within the passenger compartment to open a duct extending between an interior opening on the rear deck behind the rear seat and an exterior opening on the side of the vehicle to reduce the throb sound from an open sun roof.

U.S. Patent Application Publication No. 2008/0113600, filed by Heung Kim on Dec. 29, 2006, and published on May 15, 2008, is directed to an apparatus that alleviates wind throb conditions by sensing the conditions under which wind throb would normally be present within the vehicle, e.g. sensing that a window has been opened and that the speed of the vehicle is greater than a threshold speed value, and then actuating a blower fan to extract air from the vehicle cabin to be exhausted through a port on the side of the vehicle.

Accordingly, it would be desirable to provide an air extractor that will sense when an increase in air pressure has been encountered, such as the operating conditions that exist corresponding to the creation of wind throb, and open a vent in the rear of the vehicle to provide a flow path of air through the vehicle without allowing pressure build-up.

It would also be desirable to provide an apparatus that will relieve an increase in air pressure within the vehicle cabin without requiring a supplemental fan extracting air through a duct to be exhausted from the vehicle.

### SUMMARY OF THE INVENTION

It is an object of this invention to overcome the aforementioned disadvantages of the known prior art by providing an air extraction apparatus that senses the existence of wind throb conditions and opens a conduit to provide an airflow externally of the vehicle.

It is a feature of this invention that the air entering a single open window in a moving automobile can find a flow path through the vehicle.

It is an advantage of this invention that the air within the passenger compartment does not undergo a pressure build-up when air from outside the vehicle is passing through a single open window in the vehicle.

It is another feature of this invention that the air extraction opening is located within said passenger compartment to provide a discharge opening for air flowing through said passenger compartment without passing outwardly through a window.

It is another advantage of this invention that the air extraction opening can be formed in a rearward facing portion of the vehicle.

It is still another feature of this invention that the air extraction opening is covered with a movable closure member that is selectively movable to open and close the air extraction opening.

It is another advantage of this invention that the movable closure member for the air extraction opening can be opened when wind throb conditions are sensed to open an air flow path through the passenger compartment of the vehicle.

It is yet another feature of this invention that the closure member for the air extraction opening is moved by an actuator that is operably connected to a sensor that detects wing throb operating conditions to open the closure member in response to a sensing of wind throb conditions.

It is a further feature of this invention that the air extraction opening can be located on the rear deck of the vehicle at a position corresponding to the license plate of the vehicle.

It is another feature of this invention that an increase in air pressure within the vehicle cabin can be sensed and then relieved through the opening of an air extraction opening in the vehicle.

It is a further advantage of this invention that an actuator operably controlling the movement of a closure member for the air extraction opening can be actuated upon the sensing of an increase in air pressure within the vehicle cabin, whether the air pressure is simply a build-up or oscillating pressure changes.

It is still another advantage of this invention that the air extraction opening can be configured to be variable in cross-sectional area to vary the air flow through the passenger compartment of the vehicle.

It is another object of this invention to provide an air extraction apparatus to reduce wind throb conditions and other air pressure increases in the cabins of automotive vehicles, which is durable in construction, inexpensive of manufacture, carefree of maintenance, facile in assemblage, and simple and effective in use.

These and other objects, features and advantages are accomplished according to the instant invention by providing an air extraction apparatus for automotive vehicles to open an air flow path through the passenger compartment of the vehicle when wind throb conditions are sensed in the operation of the vehicle. The air extraction opening is located in a rear facing surface of the vehicle and is covered by a closure member that is movable by an actuator to selectively open the air extraction opening. The air extraction opening can be variable in cross-sectional area through the operation of the closure member to vary the rate of air flowing through the passenger compartment. The actuator is operatively coupled to a sensor that can sense wind throb conditions to affect an automatic opening of the air extraction opening. Wind throb conditions can be the existence of a single open window coupled with a minimum operating speed, or a threshold interior air pressure within the passenger compartment.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a right rear perspective view of a representative automotive vehicle incorporating the principles of the instant invention, arrows indicating the flow path of air from the exterior of the vehicle through the single open window through the passenger compartment and exiting the air extraction opening;

FIG. 2 is right rear perspective view of a representative automotive vehicle experiencing wind throb conditions as known in the prior art, the arrows indicating the flow of air from outside the vehicle into and out of the single open window;

FIG. 3 is a right rear perspective view of a representative automotive vehicle incorporating the principles of the instant invention;

FIG. 4 is a partial cross-sectional view of the rear hatch door corresponding to lines 4-4 of FIG. 1, the movement of the closure member being depicted by a generally vertical arrow;

FIG. 5 is a rear elevational view of the air extraction apparatus corresponding to the circle 5 in FIG. 3, the movement of the closure member being represented by the solid generally vertical arrow;

FIG. 6 is a rear elevational view similar to that of FIG. 5, but depicting an alternative pivoted embodiment of the air extraction apparatus;

FIG. 7 is a rear elevational view similar to that of FIG. 5, but depicting another alternative embodiment of the air extraction apparatus;

FIG. 8 is a rear elevational view similar to that of FIG. 5, but depicting still another alternative embodiment of the air extraction apparatus;

FIG. 9 is a rear elevational view similar to that of FIG. 5, but depicting an alternative configuration of the air extraction opening;

FIG. 10 is a right rear perspective view of an automotive vehicle incorporating another alternative configuration of the air extraction opening located around the rear light fixtures on the vehicle;

FIG. 11 is a front elevational view of the interior of the rear hatch door of the vehicle depicted in FIG. 3 to show the decorative screen covering the air extraction opening on the interior of the door; and

FIG. 12 is a logic flow diagram of the control mechanism for sensing wind throb conditions in an automobile and operating the air extraction apparatus in response thereto.

### DETAILED DESCRIPTION OF THE PREFERRED EMBODIMENT

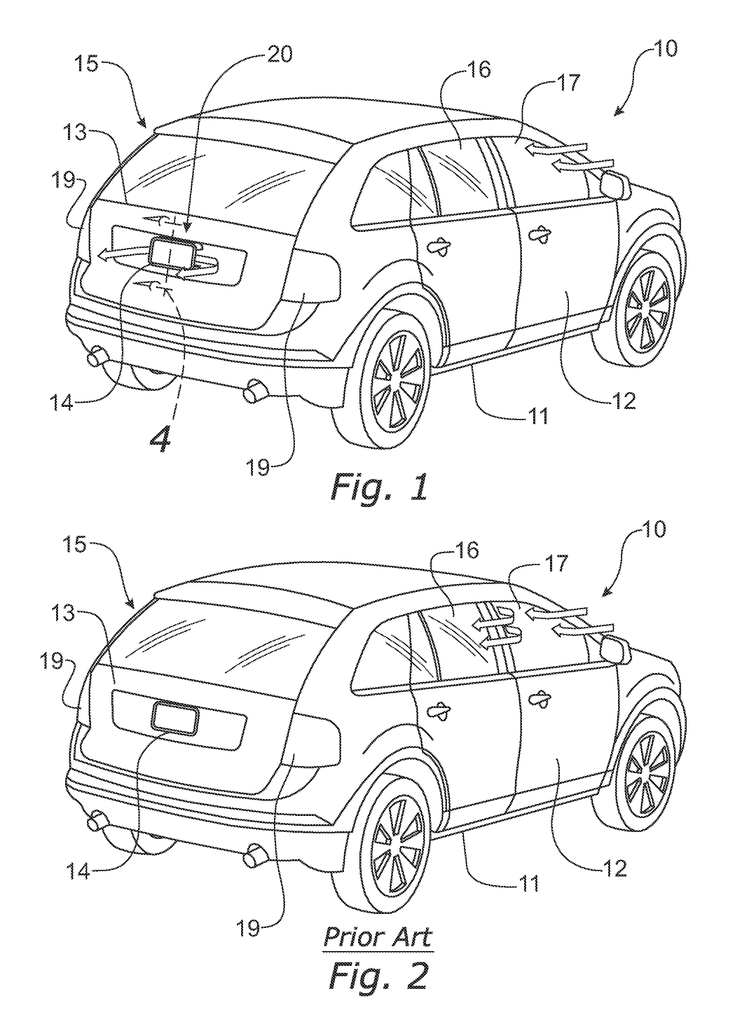

Referring to FIGS. 1-5, an automotive vehicle incorporating the principles of the instant invention can best be seen. Any references to left, right, front or rear being used as a matter of convenience and are determined be standing at the rear of the vehicle, such as at the left side of the drawing of FIGS. 1-3, and looking at the forward end into the normal direction of travel. With this definition in a vehicle constructed for conventional operation in the United States of America, the driver's side would be on the left side of the vehicle, while the passenger side would be on the right side of the vehicle. While the instant invention is best utilized in conjunction with an automotive vehicle having substantially flat-sided vehicles, such as sport utility vehicles (SUV) and cross-over vehicle, as is shown in the drawings, one of ordinary skill in the art will recognize that other vehicles, such as pick-up trucks and cars, can also be equipped with the air extraction apparatus described in greater detail below. One of ordinary skill in the art will also recognize that the instant invention can be utilized to alleviate substantially any increases in air pressure within the vehicle cabin, such as can be encountered with the closing of a vehicle door with all of the windows within the vehicle being closed.

The vehicle 10 is provided with a body 12 mounted on the frame 11 of the vehicle 10 and defining an operator and passenger compartment 15. The passenger compartment 15 is typically provided with multiple windows 16 that can be selectively raised or lowered to control the flow or exterior air into the passenger compartment 15. When a single window is opened, such as the front passenger window 17, without any of the other windows 16 being opened, a low frequency pressure pulsation is encountered with the vehicle moving forwardly at a given minimum speed of operation. This low frequency pressure pulsation is commonly referred to as wind throb and is caused by the air entering the vehicle 10 trying to be in equilibrium with the air that already fills the passenger compartment 15. The single open window 17 provides the single path for air to both enter the passenger compartment 15 and to exit the passenger compartment 15, as is represented in the prior art drawing of FIG. 2.

To provide an air flow path through the passenger compartment 15 without requiring an additional open window 16, an air extractor apparatus 20 is provided within the passenger compartment, preferably at a rear portion of the vehicle, such as within the rear hatch door 13 at a central location such as behind the license plate 14. The central location of the air extractor apparatus 20 provides an equal length flow path from opposing windows 16 irrespective of the side of the vehicle 10 on which the single open window 17 is located. Alternatively, the air extractor apparatus 20 could be located at the lateral sides at the rear of the vehicle 10, such as behind the light fixtures 19 as is depicted in FIG. 10. The air extractor apparatus 20 could also be located in the undercarriage of the vehicle. Accordingly, one of ordinary skill in the art will recognize that the air extractor apparatus 20 needs to be located so that it is conducive to interior air extraction equal to the volume of air entering the passenger compartment 15 when wind throb conditions exist.

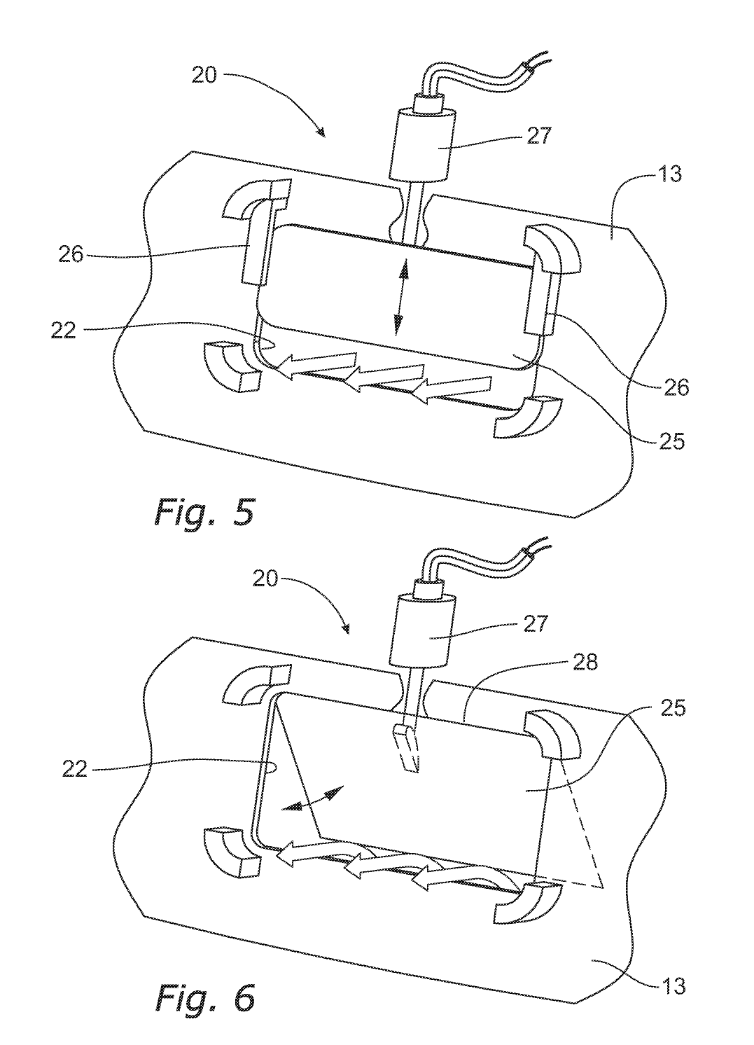

The air extractor apparatus 20 includes an air extraction opening 22 formed through the body of the vehicle, such as through the rear hatch door 13. The air extraction opening 22 is closed by a movable closure member 25 that is connected to an actuator 27 that causes the closure member 25 to move and, thereby, open and close the air extraction opening 22 in a selective manner. In the first embodiment of the air extractor apparatus 20 shown in FIGS. 4 and 5, the closure member 25 is a linearly movable planar member mounted in a slide track 26 to facilitate movement of the closure member 25 vertically to open and close the air extraction opening 22. The open cross-sectional area of the air extraction opening 22 can be selectively varied by the height to which the closure member 25 is moved. For example, if only light wind throb conditions exist, the closure member 25 could be moved only slightly, while severe wind throb conditions would result in a greater vertical movement of the closure member 25 and, therefore, the size of the opening 22. Accordingly, no supplemental fan mechanism is necessary to draw air from the passenger compartment to discharge the air from the vehicle through the air extraction opening.

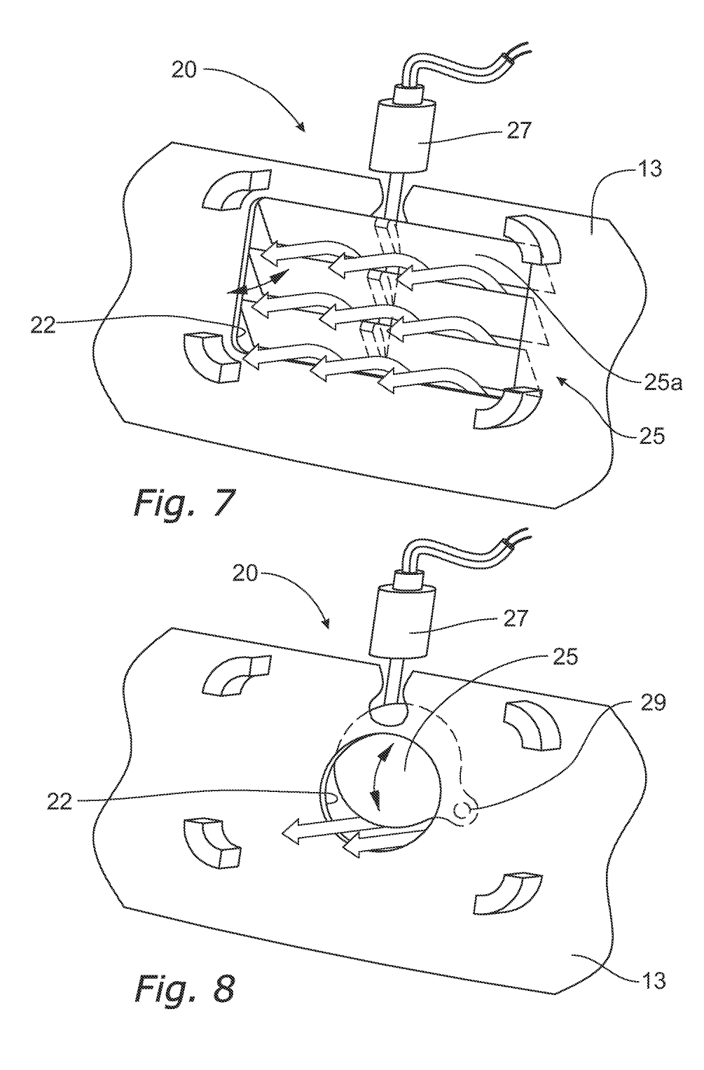

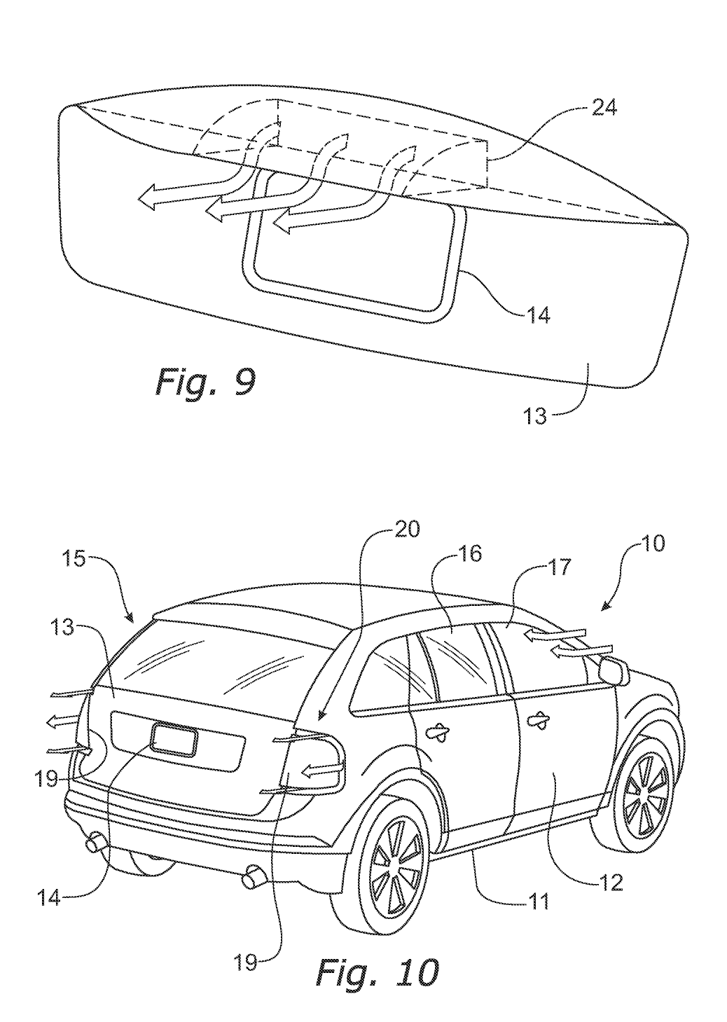

Alternative representative configurations for the closure member 25 are shown in FIGS. 6-8. In FIG. 6, the closure member 25 is pivotally mounted about a generally horizontal transverse pivot axis 28, such as along the top edge of the closure member 25 such that the retraction and extension of the actuator 27 causes a corresponding pivotal movement of the closure member 25 to open and close the air extraction opening 22 in a variable manner. Similarly, in FIG. 8, the closure member 25 is pivotally mounted for movement about a generally horizontal longitudinal pivot axis 29 so that the closure member 25 is movable vertically about an arc about the pivot axis 29 to open and close the air extraction opening 22. In FIG. 7, the closure member 25 is louvered with the individual louvers interconnected so that the connection of the actuator 27 to the top louver 25a causes pivotal movement of all of the louvers to open and close the air extraction opening 22.

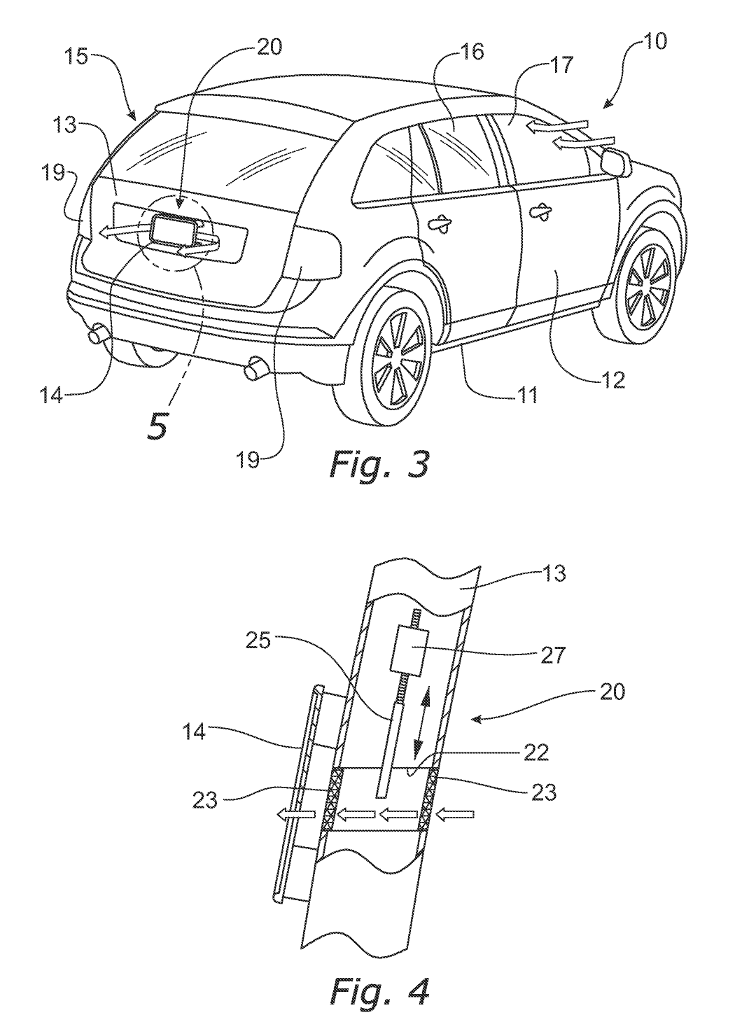

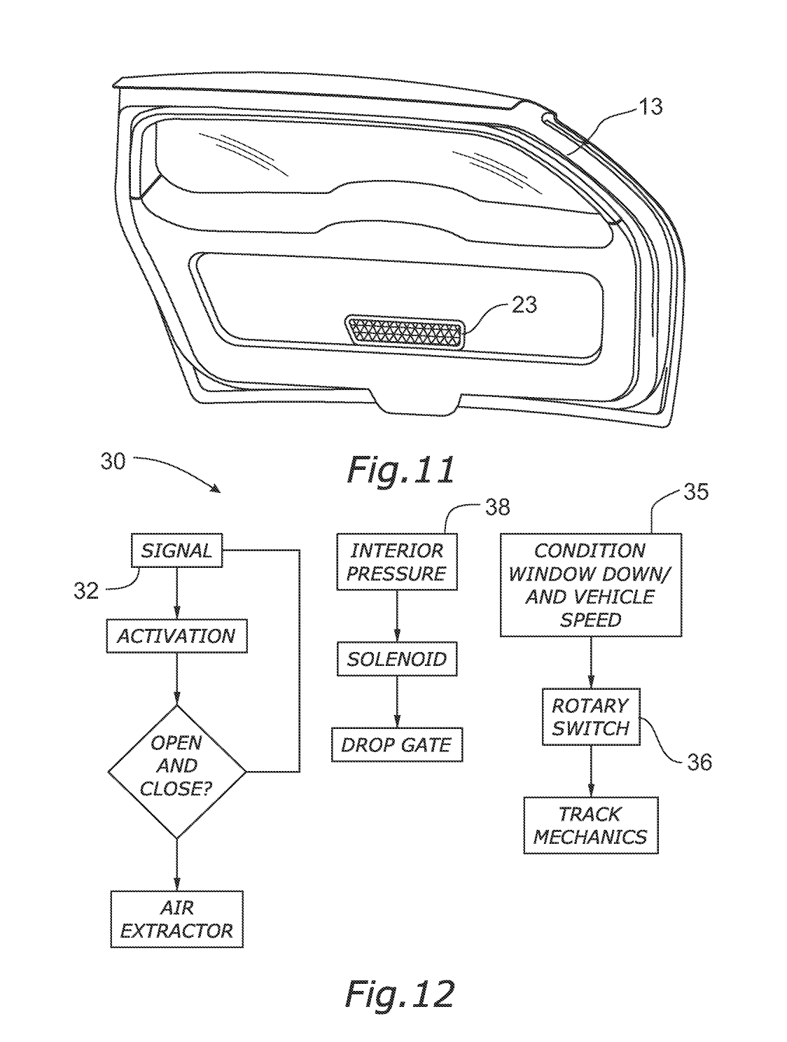

Exiting the air flow from the vehicle 10 can be accomplished by allowing the exiting air flow to depart the rear hatch door 13 and flow around the license plate 14, as is represented in FIGS. 1 and 3. A deflector hood 24 could also be employed to limit the access of rain and dirt from the exterior of the vehicle 10 to enter the rear side of the air extraction opening 22. Further, as is depicted in FIG. 10, similar air extractor apparatus 20 could be housed in the vehicle body behind the respective rear light fixtures 19, as is represented in FIG. 10, so that the exiting air flow can be directed around the light fixtures 19. Preferably, a filtering screen 23, which could be decorative, particularly on the interior of the rear hatch door 13, could be placed on opposing ends of the air extraction opening 22, as is depicted in FIGS. 4 and 11, to protect the air extractor apparatus 10.

A control mechanism 30 is housed within the passenger compartment 15 to sense the existence of wind throb conditions and to initiate the operation of the actuator 27 that opens the air extraction opening. The control mechanism 30 can include a sensor 32 that generates a signal 33 to cause the actuator 27 to open or close the air extraction opening 22. This sensor 32 can be operable in conjunction with the electronic control module 35 to sense the opening of a predetermined number of windows 16, typically a single window 17, when the vehicle 10 is moving at a speed greater than a threshold speed. These minimum parameters of a single open window and a minimum operating speed signals the existence of wind throb conditions. As a result, a switch 36 is activated and the actuator 27, which can be a solenoid or a worm gear actuator, for example, opens the closure member 25. The height of the closure member 25 can be a function of the operating speed of the vehicle 10. The greater the operating speed, the higher the closure member is raised. The parameters for establishing the existence of wind throb conditions and the subsequent actuation of the air extraction apparatus 20 will vary from one vehicle to another. Therefore, the control mechanism 30 would be customized and, thus, reflect the geometric configuration of the vehicle. For example, on vehicle “A”, minimum wind throb conditions could be the parameters of one window opened and a minimum operating speed of 60 MPH, while on vehicle “B” wind throb may occur with two windows down and a minimum operating speed of 40 MPH due to the geometric configuration of the vehicle. Accordingly, the control mechanism 30 will be programmed with the parameters under which wind throb will start to happen.

The sensor 32 could also be a pressure transducer 38 that is mounted is an appropriate location within the passenger compartment, such as on the instrument panel (not shown). When the pressure transducer 38 detects a pressure pulsation or an increase or decrease in air pressure within the passenger compartment, a signal is generated to activate operation of the actuator 27 and provide an air flow path through the passenger compartment 15. The height of the closure member 25 can be a function of the continued presence of the pressure pulsation, e.g. the closure member 25 opens the air extraction opening 22 until the pressure pulsations stop. The pressure transducer 38 can also be coupled with the electronic control module 35 to be operable only when a single window 17 is open to create a wind throb condition.

When the wind throb conditions have been eliminated, such as if all windows 16 are closed, or another window 16 is opened, the actuator 27 is signaled to close the air extraction opening 22. Thus, the air extraction apparatus 20 is only operable when wind throb or wind throb conditions exist. Under all other conditions, the closure member 25 closes the air extraction opening 22. Furthermore, the actuator 27 can be operated to narrow the cross-sectional area of the air extraction opening 22 when the speed of the vehicle diminishes, or when the pressure pulsations dissipate to position the closure member 25 at an optimum position. A pulsed monitoring of the wind throb conditions and a comparison of the existing wind throb conditions to the parameters established for operation of the air extractor apparatus 20 will provide operative control for the closing or continued opening of the air extractor apparatus 20. The pulsed monitoring could be on a millisecond to a second time periodicity.

The closing of a vehicle door when all of the windows of the vehicle are closed can also generate an increase in air pressure that the pressure transducer 38 can detect as the door is being closed. In such situations, the pressure transducer 38 sends a signal to the actuator 27 to open the closure member 25 an provide an air flow path through the air extraction opening 22 to prevent the pressure increase within the passenger compartment 15 and facilitate the closing of the vehicle door. Alternatively, or in addition, the control mechanism 30 can sense when a vehicle door is open and whether the windows within the passenger compartment 15 are closed, which conditions would allow for the increase in air pressure within the passenger compartment 15 when the door is subsequently closed. Thus, the control mechanism 30 can anticipate the conditions under which air pressure increases can be incurred and open the closure member 25 in advance of the vehicle door being closed, or as the door is being closed and the pressure transducer 38 senses an air pressure increase. The opening of the air extraction opening 22 prevents the air pressure build-up and permits the door to be closed with ease.

In operation, the air extractor apparatus 20 remains inoperative with the closure member 25 sealing off the air extraction opening 22 until the control mechanism 30 senses the presence of wind throb conditions, such as the electronic control module 35 registering that only one window 17 has been opened and the vehicle is moving forwardly at a speed greater than a threshold speed, or alternatively a pressure transducer 38 registers the presence of a pressure pulsation from the single open window 17. At this time, the actuator 27 is automatically operated to move the closure member 25 and open the air extraction opening 22 to create a flow path for air moving through the passenger compartment 15. The respective position of the closure member 25, which corresponds to the area of the open air extraction opening 22 and the volume of air that can be moved through the passenger compartment 15 to alleviate the wind throb pulsations. When the wind throb conditions are eliminated, such as another window 16 being opened, the open window 17 being closed, or the velocity of the vehicle dropping below a minimum threshold velocity, the control mechanism 30 operates the actuator 27 to close the air extraction opening 22 to remain inoperative until wind throb or wind throb conditions are sensed again.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An automotive vehicle having a body defining a passenger compartment having a plurality of laterally facing windows that are respectively movable between open and closed positions and a rearwardly facing surface, comprising:
an air extractor apparatus including a vertically oriented and rearwardly facing exterior air extraction opening formed in said passenger compartment in said rearwardly facing surface and a closure member movably mounted at said air extraction opening, said closure member being variably movable between a fully open position in which air can flow through said air extraction opening from said passenger compartment exteriorly of said automotive vehicle, and a closed position in which said air extraction member is closed to the passage of air therethrough, said air extraction opening providing a vent to said passenger compartment without utilizing air moving apparatus to move air from said passenger compartment, said closure member being connected to an actuator to affect movement thereof between said fully open position and said closed position; and
a control mechanism operably connected to said actuator to affect operation thereof upon sensing wind throb conditions within said passenger compartment, said control mechanism being operable to vary the position of said closure member to vary the size of said air extraction opening in response to the wind throb conditions sensed.

2. The automotive vehicle of claim 1 wherein said rearwardly facing surface is a rear hatch door, said air extraction opening being located centrally on said rear hatch door.

3. The automotive vehicle of claim 1 wherein said rearwardly facing surface is a one or more lighting fixtures on a rear portion of said automotive vehicle.

4. The automotive vehicle of claim 1 wherein said control mechanism identifies when a predetermined number of said windows is opened and said vehicle is operating above a threshold velocity.

5. The automotive vehicle of claim 1 wherein said control mechanism identifies a pressure pulsation within said passenger compartment.

6. The automotive vehicle of claim 1 wherein said closure member includes a pivoted member mounted for pivotal movement within said rear hatch door to open and close said air extraction opening.

7. The automotive vehicle of claim 6 wherein said pivoted member includes a plurality of interconnected louvers.

8. In an automotive vehicle having a passenger compartment defining a plurality of windows movable between open and closed positions and a rearwardly facing surface, an air extractor apparatus comprising:
an air extraction opening formed in said passenger compartment to provide a discharge opening for air from said passenger compartment other than through said windows, said air extraction opening being vertically oriented and facing rearwardly;
a closure member mounted at said air extraction opening and being selectively movable between an open position and a closed position, said open position of said closure member enabling said air extraction opening to provide an exterior vent to said passenger compartment without utilizing air moving apparatus to move air from said passenger compartment;
an actuator coupled to said closure member to affect movement thereof; and
a control mechanism operatively connected to said actuator to sense a predetermined condition associated with an increase in air pressure within said passenger compartment and to cause said actuator to move said closure member to open position such that said air extraction opening allows air to flow from said passenger compartment and exit said vehicle through said air extraction opening.

9. The automotive vehicle of claim 8 wherein said rearwardly facing surface is a rear hatch door, said air extraction opening being located centrally on said rear hatch door.

10. The automotive vehicle of claim 8 wherein said closure member is pivotally mounted at a pivot axis for movement between said open and closed position, said actuator being operable to affect pivotal movement of said closure member.

11. The automotive vehicle of claim 10 wherein said closure member is formed as a plurality of interconnected louvers, each said louver being pivotable about a transverse pivot axis.

12. The automotive vehicle of claim 8 wherein said predetermined condition includes a number of said windows being opened and said vehicle is operating above a threshold velocity.

13. The automotive vehicle of claim 12 wherein said control mechanism identifies a pressure pulsation within said passenger compartment.

14. The automobile vehicle of claim 8 wherein said predetermined condition includes sensing an increase in air pressure within said passenger compartment.

15. The automobile vehicle of claim 8 wherein said predetermined condition includes one of said doors being opened and all of said windows being closed.

16. An air extraction apparatus in an automotive vehicle having a passenger compartment defining a plurality of windows movable between open and closed positions and a rearwardly facing surface, comprising:
an air extraction opening formed in said passenger compartment to provide a discharge opening for air to the exterior of said automotive vehicle from said passenger compartment other than through said windows, said air extraction opening being vertically oriented and facing rearwardly;
a closure member mounted at said air extraction opening and being selectively variably movable to open and close, respectively, said air extraction opening to provide an exterior vent to said passenger compartment;
an actuator coupled to said closure member to affect movement thereof; and
a control mechanism operatively connected to said actuator to sense parameters within said passenger compartment associated with an increase in air pressure within said passenger compartment, said control mechanism causing said actuator to move said closure member to open said air extraction opening to allow air to flow through said passenger compartment and exit said vehicle through said air extraction opening.

17. The air extraction apparatus of claim 16 wherein said closure member is mounted for pivotal movement between said open and closed positions.

18. The air extraction apparatus of claim 17 wherein said closure member is formed as a plurality of interconnected louvers with each louver being pivotally movable about a separate pivot axis.

19. The air extraction apparatus of claim 18 wherein said closure member is located on said rearwardly facing surface.

20. The air extraction apparatus of claim 19 wherein control mechanism senses predetermined vehicle conditions associated with increases in air pressure within said passenger compartment.
